(19) United States
(12) Patent Application Publication
(10) Pub. No.: US 2006/0005880 A1
(43) Pub. Date: Jan. 12, 2006

(54) Air and water hose apparatus for firefighters

(75) Inventors: Fred E. Baker, Eaton Rapids, MI (US); Roger Badgett, St. Johns, MI (US)

Correspondence Address: Mary M. Moyne;McLEOD & MOYNE, P.C., 2190 Commons Parkway, Okemos, MI, 48864, US

(73) Assignee: Fred E. Baker, Eaton Rapids, MI (US)

(21) Appl. No.: 11/223,218

(22) Filed: Sep. 9, 2005

Related U.S. Application Data
(63) Continuation-in-part of application No. 10/359,799, filed on Feb. 6, 2003, now Pat. No. 6,941,946.
Application No. 10/359,799 is a continuation-in-part of application No. 09/802,597, filed on Mar. 9, 2001, now Pat. No. 6,520,178.

(51) Int. Cl. A62C 35/00

(52) U.S. Cl. 137/355.16

(57) ABSTRACT

A hose apparatus used as part of an air and water supply system to deliver water and air to a firefighter. The hose apparatus includes an air hose and a water hose with an adaptor at each end of the air and water hoses. The adaptors have an inner passageway with an air groove. The adaptors have a first air hole in fluid communication with the air hose and the air groove and a second air hole in fluid communication with the air groove and the air supply or breathing hose for the firefighter. The second air hole has a coupling which prevents air from exiting the adaptors when the hose apparatus is not in use.

### CROSS-REFERENCE TO RELATED APPLICATIONS

This application is a continuation-in-part of application Ser. No. 10/359,799 filed Feb. 6, 2003, which is a continuation-in-part of application Ser. No. 09/802,597 filed Mar. 9, 2001, now U.S. Pat. No. 6,520,178.

### STATEMENT REGARDING FEDERALLY SPONSORED RESEARCH OR DEVELOPMENT

Not Applicable

### BACKGROUND OF THE INVENTION

(1) Field of the Invention

The present invention relates to an air and water hose apparatus and the method of using the air and water hose apparatus to supply air and water to firefighters during a fire. In particular, the present invention relates to a hose apparatus which has air and water hoses and which has adaptors mounted on each end of the air and water hoses which enable air and water to be provided to a firefighter.

(2) Description of the Related Art

One of the dangers that firefighters face is being trapped or lost in the structure which is on fire. One of the main reasons that firefighters die in such a situation is that they run out of air. Currently, in most situations, air is supplied to the firefighter by tanks carried by the firefighter. Most of these tanks, due to their size and weight, have very limited air supply. Thus, if a firefighter is trapped for an extensive period of time, the supply is eventually exhausted which usually results in the death of the firefighter.

In the past, various systems have been developed which try to supply air to a firefighter from a distant source. Illustrative are U.S. Pat. No. 386,751 to Loomis, U.S. Pat. No. 958,427 to Panian, U.S. Pat. No. 1,040,311 to Halloran and U.S. Pat. No. 4,974,584 to Goodnoe.

Loomis shows an apparatus which has an air tube combined with a fire hose. The outer end of the air tube connects with a flexible air-tube which connects to the mask of the firefighter. The air tube and fire hose have independent unions such that several sections of the apparatus can be connected together. When connecting the sections together, the air tube extends around the outside of the fire hose union. This design exposes the air tube to possible damage which could stop the flow of air through the tube. The air is supplied by an air pump. This system is only intended to operate using air at low pressures such as atmospheric pressure. This system could not be used in conjunction with the compressed air systems currently used by firefighters. The air hoses of current compressed air systems have an inner diameter usually less than 1.0 inch (2.54 cm). The small size of the inner diameter of the air hose would not allow enough air at atmospheric pressure to travel through the air hose to support the firefighter.

Panian describes a respirating apparatus where the air is provided to the mask of the firefighter through a flexible tube which extends along the outside of the water hose. The air is supplied to the air tube by bellows which are actuated by water in the water hose rotating a wheel connected to the bellows. One of the disadvantages of this system is that the flow of air depends on the flow of water. If for any reason the water in the hose were to stop running, the firefighter's air supply would also stop. In addition, as with the apparatus of the Loomis reference, the positioning of the air tube on the outside of the water hose exposes the air tube to possible damage which could stop the flow of air through the tube. In current systems using high pressure, compressed air, air which leaks from a damaged air tube could potentially feed the fire.

Halloran shows an air supply device which uses an air suction chamber attached to one end of the fire hose. The air suction chamber is configured to draw fresh air into the chamber through a pipe due to the suction action of the water passing through the fire hose. Funnels in the chamber collect the air entering the air suction chamber and transfer the air through pipes to the firefighter's masks. However, this system is very unreliable. In addition, as with the apparatus of the Panian reference, if for any reason the water in the hose were to stop running, the firefighter's air supply would also stop.

Goodnoe describes an emergency air supply assembly for firefighters. In this invention, the water supply for the water hose is shut off and the emergency air is provided to the firefighter through the water hose. The end of the water hose is placed in an emergency air collector which collects the air. The firefighter then inserts his breathing tube into the air collector. This system is difficult to use. However, a more substantial disadvantage of this system is that the water must be turned off before air can be supplied. Thus, the firefighter must choose between having water to fight the fire and having air to breathe. Further, this system uses air at low pressures and can only be used as an emergency system.

Currently, as shown in the publication by the Fire Protection Publications Oklahoma State University entitled “Second Edition, Self-Contained Breathing Apparatus” pages 66-67, an air line can be provided to allow for a longer air supply than is provided by a self-contained breathing apparatus having a tank carried by the firefighter. This air line is attached at one (1) end to one or several air cylinders and is connected at the other end to an open circuit face piece, regulator, and egress cylinder of the firefighter. However, this air line is exposed and therefore is not intended to be used by a firefighter in a burning structure.

Also, of interest are U.S. Pat. No. 174,286 to Ostberg; U.S. Pat. No. 1,084,958 to Panian and U.S. Pat. No. 2,515,578 to Wilson et al. Ostberg describes a fireman's suit which is supplied with water and air by a hose. The hose has an inner air pipe and an outer surrounding water pipe. Panian describes a smoke and heat protector for firemen which supplies air and water to the firemen. The air hose is fastened on the exterior of the water hose. Wilson et al. describes a firefighting device which conducts mist or fog from the fluid stream within the nozzle to the mask of the firefighters.

Only of minimal interest are U.S. Pat. No. 916,886 to Merryman; 1,808,281 to Balthazor; U.S. Pat. No. 4,649,912 to Collins and U.S. Pat. No. 5,095,899 to Green. Merryman describes an air accumulator mounted on the nozzle of a fire hose. The air accumulator has chambers which communicate with tubes which are connected to the user to allow fresh air to be supplied to the user and exhaust air removed. Balthazor describes an air device which mounts adjacent to the water discharge end of a fire hose and collects fresh air from the stream of eater passing through the nozzle. The air supply device includes a means for conducting the fresh air from the nozzle to the user's mouth. The air supply device also includes a fan for preventing smoke from entering the air supply device when the user is not intaking fresh air. Collins describes an air respirator system for painters. The air supply for the painter is removed from the compressed air line which supplies air to the paint sprayer from the compressor. Green describes an air delivery system which uses the water hose to deliver air to firefighters in an emergency. The system requires the water to be purged from the water hose before the water hose is used to deliver air to the firefighters.

There remains the need for an air and water hose apparatus and method for supplying air and water to a firefighter from a distant source using a single hose apparatus which allows air to be delivered to the firefighter without interfering with the flow of the water in the water hose and which prevents air from escaping from the hose apparatus when not in use by a firefighter.

### SUMMARY OF THE INVENTION

The present invention is an air and water hose apparatus to be used in an air and water supply system to deliver water and air to the firefighter at all times. The hose apparatus reduces the need for firefighters to rely on the limited amount of air supplied by their tanks when they are trapped in a structure or fighting a fire. The present invention includes at least one air hose extending along the length of a water hose. Adaptors are provided at each end of the air and water hoses to form the hose apparatus. An outer cover can be provided around the air hose and water hose to connect the air hose and water hose together in a single hose. The adaptors have an inner passageway into which the end of the water hose is mounted. The end of the inner passageway of the first adaptor opposite the hose apparatus is connected to the water supply and acts as a water inlet. The end of the inner passageway of the second adaptor has a nozzle and acts as a water outlet. The inner passageway has an air groove which extends around the inner surface of the inner passageway. The inner passageway also has seals which form an air tight air passageway between the water hose and the air groove. The adaptors have a first air hole which is in fluid communication with the air hose and the air groove. The adaptors also have a second air hole in fluid communication with the air groove. In the first adaptor, the second air hole is connected to the air supply and acts as an air inlet. In the second adaptor, the breathing hose of a firefighter is connected to the second air hole and the second air hole acts as an air outlet. A coupling having a one-way valve can be connected to the second air hole. When the air supply or the breathing hose is connected to the coupling, air can flow into or out of the air hose through the second air hole and the coupling. When the air supply or the breathing hose is disconnected from the coupling, the valve is closed preventing air from entering or exiting the air hose. A pressure regulating device can be positioned between the air supply and the second air hole on the first adaptor. In one (1) embodiment, the hose apparatus is only a single section of the overall water hose of the fire hose. This ensures that no part of the air hose extends outside the hose apparatus and is exposed to possible damage.

The present system can be used as a primary air supply system allowing the air tanks carried by the firefighter to be used only for emergency purposes. Alternatively, the air and water supply system can be used as an emergency system to be used when the air tanks carried by the firefighter have been exhausted. The system enables a firefighter to easily switch between the hose apparatus and the standard air tanks. The air and water supply system supplies high pressure air similar to that supplied by the tanks carried by firefighters. The system allows a user to easily connect and disconnect the air supply to the firefighter's mask. The system can be used with standard self-contained breathing apparatus used by firefighters including a mask and a regulator.

The present invention relates to a hose apparatus for providing air and water to a firefighter which comprises: a water hose having opposed ends with an inner passageway extending therebetween; at least one air hose having opposed ends with an inner passageway extending therebetween and positioned adjacent to the water hose so that the first end of the air hose is adjacent to the first end of the water hose; and an adaptor having a first end and a second end with an inner passageway extending therebetween and having a first air hole, a second air hole, the inner passageway having an inner surface with an air groove wherein the adaptor is configured to be connected to one end of the water hose and one end of the air hose so that the inner passageway of the adaptor is in fluid communication with the inner passageway of the water hose and the air groove in the inner surface of the inner passageway is in fluid communication with the inner passageway of the air hose.

Further, the present invention relates to an adaptor for mounting on an end of a hose apparatus having a water hose and an air hose, which comprises: a first end configured to receive an end of the water hose of the hose apparatus and a second end with an inner passageway extending therebetween, the inner passageway having an inner surface, the inner surface having an air groove; a first air hole in the first end in fluid communication with the air groove and configured to connect to the air hose of the hose apparatus; and a second air hole in the first end in fluid communication with the air groove.

Still further, the present invention relates to a method for providing air and water to a firefighter during a fire which comprises the steps of: providing a hose apparatus including a water hose having opposed first and second ends with an inner passageway extending therebetween and an air hose having opposed first and second ends with an inner passageway extending therebetween and positioned so that the first end of the air hose is adjacent the first end of the water hose; and a first adaptor having a first end and a second end and a first air hole and a second air hole, the first adaptor having an inner passageway with an inner surface having an air groove, the first adaptor connected at the second end to the first end of the water hose and at the first end to the first end of the air hose so that the inner passageway of the first adaptor is in fluid communication with the inner passageway of the water hose and the air groove is in fluid communication with the inner passageway of the air hose and a second adaptor having a first end and a second end and a first and second air hole, the second adaptor having an inner passageway with an inner surface having an air groove, the second adaptor connected to the second end of the water hose and the second end of the air hose so that the inner passageway of the second adaptor is in fluid communication with the inner passageway of the water hose and the inner passageway of the air hose is in fluid communication with the air groove of the second adaptor; connecting a water supply to the inner passageway of the first adaptor; connecting an air supply to the second air hole in the first adaptor; connecting a breathing hose for the firefighter to the second air hole in the second adaptor; providing water from the water supply through the first adaptor and the water hose and through the second adaptor and out through the second adaptor; and providing air from the air supply through the second air hole of the first adaptor to the air groove of the first adaptor to the first air hole of the first adaptor to the air hose to the first air hole in the second adaptor through the air groove of the second adaptor to the second air hole of the second adaptor and to the breathing hose for the firefighter.

The substance and advantages of the present invention will become increasingly apparent by reference to the following drawings and the description.

### BRIEF DESCRIPTION OF THE DRAWINGS

FIG. 1 is a perspective view of the system 100 showing the fire truck 116, the standard water hose 102, the hose apparatus 10 and the firefighters 150.

FIG. 2 is an exploded, cross-sectional view of the first adaptor 30 and the water hose 12 and showing the air hose 26 and the protective cap 40.

FIG. 3 is a cross-sectional view of the first adaptor 30 connected to the water hose 12 and the air hose 26.

FIG. 4 is a cross-sectional end view before the first adaptor 30 showing the outer covering 24 around the air hoses 26 and 27 and the water hose 12.

FIG. 5 is a perspective view of the hose apparatus 10 with the pressure regulating device 50 attached to the first adaptor 30 and showing the air supply 110.

FIG. 6 is an end view of the first adaptor 30 showing the first air hole 30F, the second air hole 30G and the air groove 30I in phantom.

### BRIEF DESCRIPTION OF THE PREFERRED EMBODIMENTS

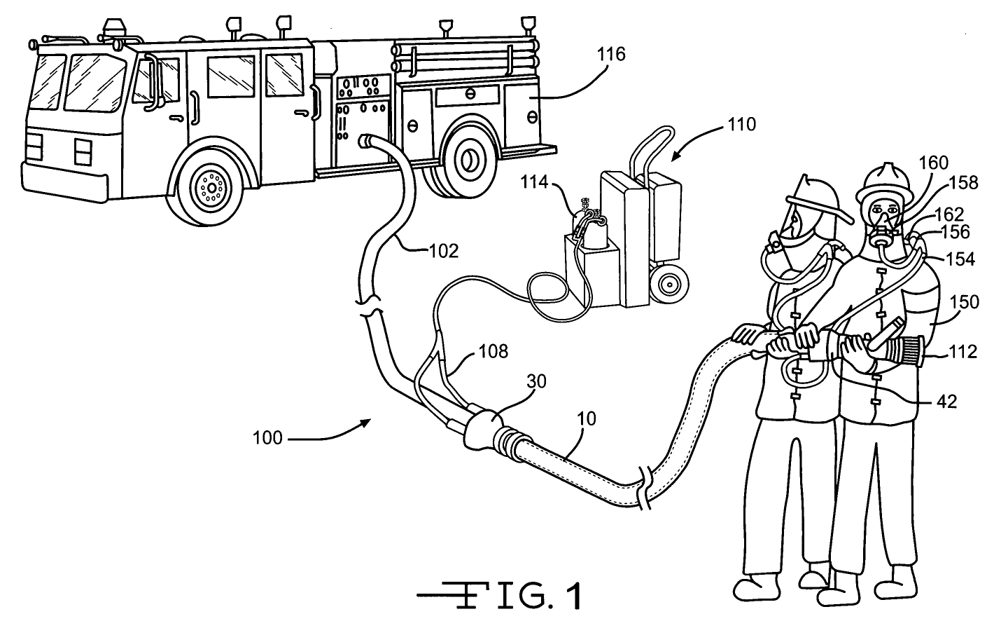

The air and water hose apparatus 10 of the present invention includes a water hose 12 and an air hose 26 extending between a pair of adaptors 30 and 42. In one (1) embodiment, the hose apparatus 10 is used in an air and water supply system 100 to provide water and air or other breathable gases to firefighters 150 (FIG. 1). The air and water supply system 100 includes the hose apparatus 10 connected at one (1) end to an air supply 110 and water supply and connected at the other end to breathing hose 154 for a firefighter 150. In one (1) embodiment, the breathing hose 154 is connected to a self-contained breathing apparatus (SCBA) used by the firefighters 150. Applicant's co-pending U.S. patent application Ser. No. 10/359,799 describes an air and water hose apparatus which includes a water hose and an air hose which can be used as part of an air and water supply system, the application is incorporated herein by reference in its entirety.

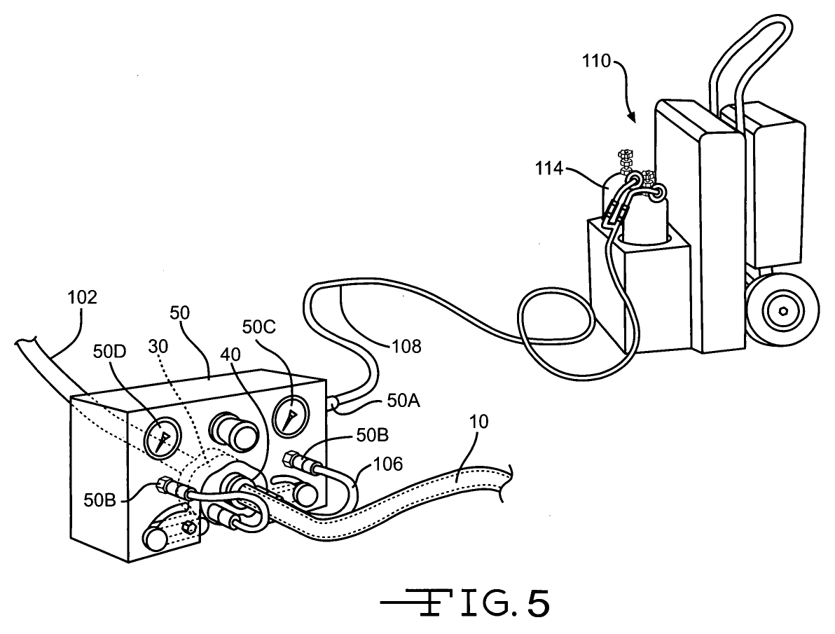

In one (1) embodiment, the air supply 110 is two (2) portable air tanks 114 (FIG. 5). The use of two (2) air tanks 114 allows an empty tank 114 to be replaced without stopping the flow of air to the firefighters 150. However, the air supply 110 could be any number of air tanks 114. Alternatively, the air supply 110 could be mounted on the fire truck 116. In one (1) embodiment, the air supply 110 is a high pressure air supply such as an air compressor providing air at pressures between about 2500 and 8000 psig. The water supply is similar to a standard water supply used for firefighting hoses. In one (1) embodiment, the water pressure of the water in the water hose 12 is similar to that used in standard water hoses. It is understood that other firefighting fluids or flame retardant materials could also be provided through the water hose 12 of the hose apparatus 10.

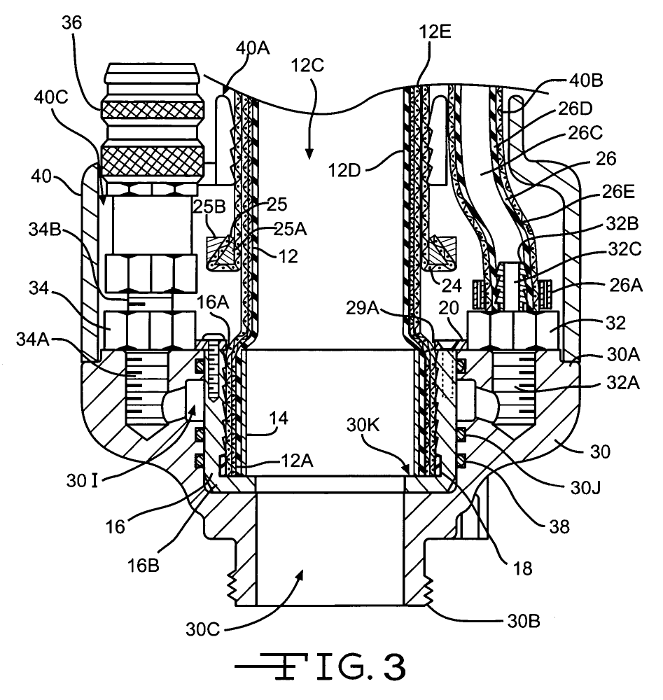

The water hose 12 of the hose apparatus 10 has a first end 12A and a second end (not shown) with an inner passageway 12C extending therebetween. In one (1) embodiment, the water hose 12 is similar to a standard firefighting water hose. The water hose 12 is constructed of several layers using materials which are durable and flexible. The water hose 12 has an inner layer 12D forming the inner passageway 12C of the water hose 12 and at least one (1) outer layer 12E. In one (1) embodiment, the water hose 12 is constructed of three (3) layers of material including an outer, durable weather resistant layer 12E, a first inner layer and a second inner, flexible layer 12D (FIG. 3). The water hose 12, in one (1) embodiment, has an inner diameter of between about 1.25 inches and 2.75 inches (3.18 to 7.00 cm).

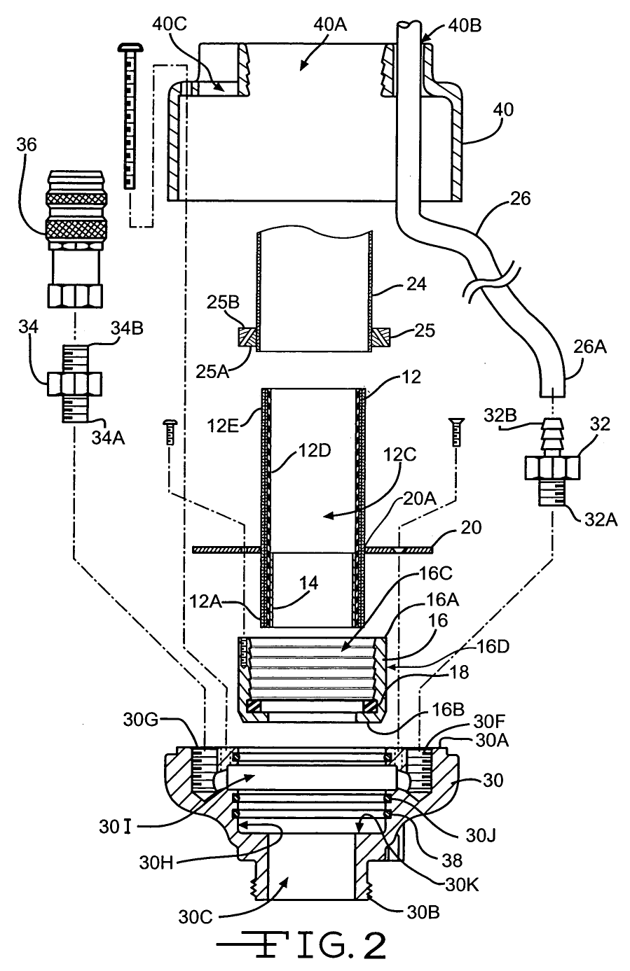

The first and second ends 12A of the water hose 12 include an expansion ring 14 in the inner passageway 12C of the water hose 12 directly adjacent the opening in the ends 12A of the water hose 12. The expansion ring 14 has a cylindrical shape. In one (1) embodiment, the expansion ring 14 is constructed of brass. A sleeve 16 is secured around the outer layer 12E of the water hose 12 at the first and second ends 12A. The sleeve 16 has a cylindrical shape with an open first end 16A and an open second end 16B with a center bore 16C extending therebetween. The diameter of the opening in the first end 16A of the sleeve 16 is greater than the diameter of the opening in the second end 16B of the sleeve 16. The water hose 12 is inserted into the center bore 16C through the opening in the first end 16A of the sleeve 16. The water hose 12 is moved into the center bore 16C of the sleeve 16 until the end 12A of the water hose 12 is adjacent to the opening in the second end 16B of the sleeve 16. The smaller diameter of the opening in the second end 16B of the sleeve 16 prevents the water hose 12 from extending through the second end 16B of the sleeve 16. In one (1) embodiment, a gasket 18 is provided in the center bore 16C of the sleeve 16 adjacent to the opening in the second end 16B so that when the water hose 12 is inserted into the sleeve 16, the gasket 18 is spaced between the end 12A of the water hose 12 and the opening in the second end 16B of the sleeve 16 (FIG. 2). In one (1) embodiment, the opening in the second end 16B of the sleeve 16 has a diameter essentially equal to the inner diameter of the water hose 12. The inner sidewall of the center bore 16C of the sleeve 16 can be provided with barbs to secure the water hose 12 in the sleeve 16 (FIG. 2).

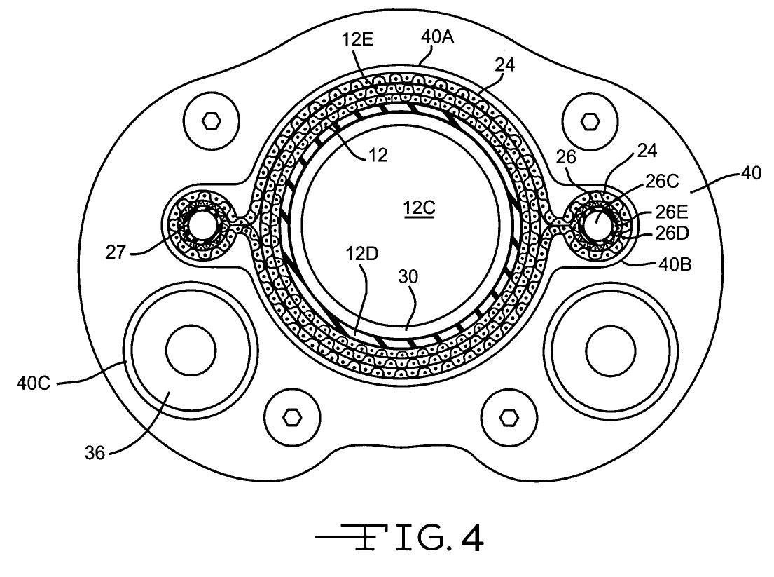

A retainer 20 is provided for mounting on the first end 16A of the sleeve 16 (FIG. 4). The retainer 20 has a center opening 20A which allows for positioning the retainer 20 on the water hose 12 prior to mounting the sleeve 16 on the water hose 12. Once the sleeve 16 is mounted on the end 12A of the water hose 12, the retainer 20 is moved along the water hose 12 until the retainer 20 contacts the first end 16A of the sleeve 16. The retainer 20 is then secured to the first end 16A of the sleeve 16.

The air hose 26 has a first end 26A and a second end (not shown) with an inner passageway 26C extending therebetween. The air hose 26 is positioned adjacent the outer most layer 12E of the water hose 12 and extends essentially parallel to the water hose 12 such that the first end 26A of the air hose 26 is adjacent the first end 12A of the water hose 12 and the second end of the air hose 26 is adjacent the second end of the water hose 12. In one (1) embodiment, the air hose 26 has a length essentially equal to the length of the water hose 12. In one (1) embodiment, the air hose 26 has an inner diameter of approximately 0.125 inches (0.040 cm) and an outer diameter of approximately 0.25 inches (0.64 cm). However, the air hose 26 can have an inner diameter of between about 0.125 inches and 0.38 inches (0.040 cm and 0.97 cm). In one (1) embodiment, the air hose 26 has an inner layer 26D and an outer layer 26E. The air hose 26 may be constructed of any well known material which can withstand high fluid pressure on the inside caused by the air moving through the air hose 26. In one (1) embodiment, the air hose 26 is capable of carrying air at a pressure of between about 75 and 5000 psig. The ability of the system 100 to operate at lower air pressures between 75 psig and 125 psig allows for the use of air hoses 26 which have an inner diameter of between 0.125 inches (0.040 cm) and 0.25 inches (0.64 cm). The ability of the air hose 26 to carry air up to 5000 psig enables the air hose 26 to be used as a means to fill the air tanks 162 of the firefighters 150. The air hose 26 must be supple enough to bend 180° and still spring back to its original shape to prevent damage to the air hose 26 due to repeated bending and folding for storage. In one (1) embodiment, the air hose 26 is constructed of a material which has memory. Thus, the air hose 26 will attempt to return to its original shape to remove any kinks in the air hose 26. The air hose 26 is constructed of a material which will not contaminate the air such as material used to construct air hoses used and approved for scuba diving. In one (1) embodiment, the inner layer 26D of the air hose 26 is constructed of reinforced rubber tubing which is approved for human use. In one (1) embodiment, the hose apparatus 10 has two (2) air hoses 26 and 27 which are spaced apart approximately 180° about the outer circumference of the water hose 12 (FIG. 4). The spacing of the air hoses 26 and 27 approximately 180° apart around the water hose 12 reduces the chances that both air hoses 26 and 27 would be kinked or closed off simultaneously. The use of two (2) air hoses 26 and 27 increases the likelihood that air will continue to flow to the firefighter 150, regardless of the position of the water hose 12.

In one (1) embodiment, an outer cover 24 extends around the air hose 26 and the water hose 12 which enables the air hose 26 to be sandwiched between the outer most layer 12E of the water hose 12 and the outer cover 24. This construction allows use of a standard fire hose as the water hose 12. The outer cover 24 provides reinforcement and another layer of protection to the water hose 12 and the air hose 26. In one (1) embodiment, the outer cover 24 is secured around the air hose 26 such that the air hose 26 is separated from the water hose 12 (FIG. 4). In one (1) embodiment, the outer cover 24 is constructed of a material similar to the material used for the layers for a standard fire hose. In one (1) embodiment where the adaptors 30 and 42 include a protective cap 40, the outer cover 24 is cut to allow separation of the portion of the outer cover 24 covering the water hose 12 from the portion of the outer cover 24 covering the air hose 26 so that only the portion of the outer cover 24 covering the water hose 12 extends into the interior of the protective cap 40. The end of the outer cover 24 is anchored between the protective cap 40 and the first side 30A of the adaptor 30 or 42. In one (1) embodiment, tubing is mounted over the outer layer 12E of the water hose 12 adjacent to and spaced apart from the ends 12A of the water hose 12. The tubing is positioned between the adaptor 30 or 42 and the protective cap 40 when the adaptor 30 and 42 is secured on the water hose 12. In one (1) embodiment, the tubing is stiff and inflexible. The tubing allows for clamping and securing the outer cover 24 on the water hose 12 without crimping or reducing the inner diameter of the water hose 12. In one (1) embodiment, a hose clamp is used to secure the outer cover 24 onto the water hose 12 (FIG. 3). In one (1) embodiment, wedge locks 25 are used to secure the outer cover 24 in the protective cap 40 (FIGS. 2 and 3). In this embodiment, the interlocking wedge locks 25 include a male wedge lock 25A and a female wedge lock 25B in the form of rings which mount over the end 12A of the water hose 12. The outer cover 24 is wrapped around the male wedge lock 25A and the female wedge lock 25B is moved over the outer cover 24 to secure the outer cover 24 between the male and female wedge locks 25A and 25B (FIG. 3).

The first adaptor 30 is connected to the first end 12A of the water hose 12 and the first end 26A of the air hose 26. The second adaptor 42 is connected to the second end of the water hose 12 and the second end of the air hose 26. The first and second adaptors 30 and 42 are similar and are connected to the ends 12A and 26A of the water hose 12 and air hose 26 similarly. Therefore, only the first adaptor 30 will be described in detail. The first adaptor 30 has a first end 30A and a second end 30B with an inner passageway 30C extending therebetween. The inner passageway 30C of the first adaptor 30 has an inner surface 30H with an air groove 30I. In one (1) embodiment, the inner passageway 30C of the first adaptor 30 has a cylindrical shape and the air groove 30I extends around a circumference of the inner surface 30H of the inner passageway 30C. In one (1) embodiment, the inner passageway 30C has a first portion adjacent the first end 30A of the first adaptor 30 and a second portion adjacent the second end 30B of the first adaptor 30. In one (1) embodiment, the diameter of the first portion of the inner passageway 30C is greater than the diameter of the second portion of the inner passageway 30C so that a shoulder 30K is formed between the first and second portion. In one (1) embodiment, the air groove 30I is located adjacent the first end 30C of the first adaptor 30 in the first portion of the inner passageway 30C. In one (1) embodiment, the inner surface 30H of the inner passageway 30C adjacent the first end 30A is provided with several grooves 30J for positioning seals to secure the water hose 12 in the inner passageway 30C of the first adaptor 30. In one (1) embodiment, the seals are o-rings 38 positioned in the grooves 30J in the inner surface 30H of the inner passageway 30C. In one (1) embodiment, the seals are located on opposite sides of the air groove 30I along the inner passageway 30C.

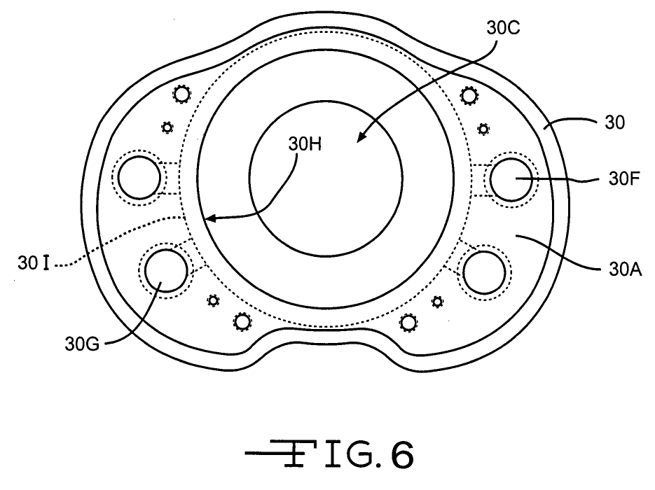

The first adaptor 30 also has a first air hole 30F and a second air hole 30G in the first end 30A. The first and second air holes 30F and 30G extend partially into the first adaptor 30 from the first end 30A of the first adaptor 30 and are in fluid communication with the air groove 30I in the inner surface 30H of the air passageway 30C of the first adaptor 30 (FIG. 6). In one (1) embodiment, the first and second air holes 30F and 30G have a side passageway adjacent the end of the first and second air holes 30F and 30G opposite the first end 30A of the first adaptor 30 which connects the first and second air holes 30F and 30G to the air groove 30I (FIG. 6). The first air hole 30F is connected to the first end 26A of the air hose 26. In one (1) embodiment, where the hose apparatus 10 has two (2) air hoses 26 and 27, the first end 30A of the first adaptor 30 has two (2) first air holes 30F. It is understood that the first adaptor 30 may have multiple first air holes 30F depending on the number of air hoses 26 and 27 used in the hose apparatus 10. The second air hole 30G of the first adaptor 30 is connected to the air supply 110. The second air hole of the second adaptor 42 is connected to the breathing hose 154 of the firefighter 150. The first adaptor 30 may have multiple second air holes 30G depending on the number of air supply tubes 108 for the air supply 110. In the second adapter 42, the number of second air holes 30G depends on the number of persons or firefighters 150 to be connected to the hose apparatus 10. In one (1) embodiment, the first and second adaptors 30 and 42 have two (2) first air holes 30F and two (2) second air holes 30G (FIG. 6).

In one (1) embodiment, the first end 26A of the air hose 26 is connected by an air connector 32 to the first air hole 30F. In this embodiment, the air connector 32 has a first end 32A and a second end 32B with a center bore 32C extending therebetween. The first air hole 30F has threads and the first end 32A of the air connector 32 is threadably mounted in the first air hole 30F. However, it is understood that the air connector 32 can be connected to the first air hole 30F by any well known means. The second end 32B of the air connector 32 is connected to the first end 26A of the air hose 26. The second end 32B of the air connector 32 is inserted into the inner passageway 26C of the air hose 26. The second end 32B of the air connector 32 has barbs which prevent the air hose 26 from slipping off of the air connector 32. It is understood that any means well known in the art could be used to connect the air hose 26 to the air connector 32 or connect the air hose 26 to the first air hole 30F. In one (1) embodiment, an air fitting 34 is secured in the second air hole 30G. The air fitting 34 has opposed ends 34A and 34B with a center bore extending therebetween. The second air hole 30G is threaded and the first end 34A of the air fitting 34 is threadably mounted in the second air hole 30G. However, it is understood that the air fitting 34 can be secured in the second air hole 30G by any well known means. In one (1) embodiment, a quick connect coupling 36 is connected to the second end 34B of the air fitting 34. The quick connect coupling 36 allows for quick and easy connecting and disconnecting of the air supply tube 108 to the first adaptor 30 or the breathing hose 154 to the second adaptor 42. In one (1) embodiment, the quick connect coupling 36 includes a valve (not shown) which when open, allows air to flow through the coupling 36 but prevents air from exiting through the coupling 36 when the valve is closed. When the air supply tube 108 or breathing hose 154 is connected to the coupling 36, the valve in the coupling 36 is open allowing air to flow through the coupling 36 to or from the air hose 26. When the air supply tube 108 or the breathing hose 154 is disconnected from the coupling 36, the valve in the coupling 36 closes preventing air or other fluid in the air hose 26 from exiting the air hose 26 through the coupling 26. The use of a coupling 36 having a one-way valve at the second end of the air hose 26 allows the user to control the flow of air adjacent the fire. This valving and control of air flow reduces the possibility that air from the air hose 26 will feed the fire when the firefighter 150 is not using the air and water supply system 100. The quick connect coupling 36 can be similar to any quick connect/disconnect coupling. In one (1) embodiment, the coupling 36 is similar to the D series automatic connect, single shut off couplings manufactured by the Perfecting Coupling Company. In this embodiment, the coupling 36 is a ¼ NPT coupling constructed of brass or stainless steel. However, the coupling 36 can be similar to any pneumatic or hydraulic quick release coupling able to handle the fluid pressures provided by the air supply 110. In one (1) embodiment, the coupling 36 is able to handle up to 5000 psig. In one (1) embodiment, the coupling 36 is a quick connect/disconnect coupling similar to the Hansen HK series couplings sold by Tuthill Coupling Group. However, it is understood that the air supply tube 108 and the breathing hose 154 can be connected to the second air holes 30G in the first and second adaptors 30 and 42, respectively by any well known means.

In one (1) embodiment, a protective cap 40 is mounted on the first end 30A of the first adaptor 30. A protective cap 40 can also be mounted similarly on the first end of the second adaptor 42. The protective cap 40 has a first opening 40A to allow the protective cap 40 to be mounted over the water hose 12. The protective cap 40 also has a second opening 40B to allow the air hose 26 to be connected to the first air hole 30F and a third opening 40C to allow access to the second air hole 30G or the quick connect air coupling 36. In one (1) embodiment, the first opening 40A and the second opening 40B are combined together as a single opening. The protective cap 40 may have additional openings depending on the number of first and second air holes 30F and 30G in the adaptors 30 and 42. The protective cap 40 reduces the possibility of damage to the air connector 32 or the air fitting 34 connected to the first and second air holes 30F and 30G, respectively. In one (1) embodiment, the first opening 40A of the protective cap 40 had barbs to hold the first end 12A of the water hose 12 in position in the inner passageway 30C of the first adaptor 30.

To construct the hose apparatus 10, the water hose 12 is constructed such that the expansion ring 12 is positioned in the inner passageway 12C of the water hose 12 adjacent each end 12A. The air hose 26 is then positioned adjacent the outer layer 12E of the water hose 12 and the outer cover 24 is extended around the air hose 26 and the water hose 12 to secure the air hose 26 and water hose 12 together. The outer cover 24 adjacent the ends 12A and 26A of the water hose 12 and air hose 26 is cut to allow separation of the water hose 12 from the air hose 26 adjacent the adaptors 30 and 42. The securing of the first and second adaptors 30 and 42 on the ends 12A and 26A of the water hose 12 and the air hose 26 is similar. Therefore, only the attachment of the first adaptor 30 will be discussed. The protective cap 40 is first mounted over the ends 12A and 26A of the water hose 12 and air hose 26 so that the water hose 12 with the outer cover 24 extends through the first opening 40A and the air hose 26 without the outer covering 24 extends through the second opening 40B in the protective cap 40. The outer cover 24 is then anchored to the protective cap 40 or the water hose 12 on the side of the protective cap 40 adjacent the first end 12A of the water hose 12. The retainer 20 is mounted over the end 12A of the water hose 12 and the sleeve 16 is mounted on the end 12A of the water hose 12. The retainer 20 is then moved toward the sleeve 16 and secured to the sleeve 16. The expansion ring 14 is then expanded in the inner passageway 12C of the water hose 12 and forces the outer layer 12E of the water hose 12 into the sleeve 16 and the gasket 18 and creates a water tight seal between the outer layer 12E of the water hose 12 and the sleeve 16. Next, the air connector 32 and the air fitting 34 are secured to the first adaptor 30. The first end 26A of the air hose 26 is then connected to the air connector 32. The first end 12A of the water hose 12 including the sleeve 16 is inserted into the inner passageway 30C of the first adaptor 30 at the first end 30A of the first adaptor 30.

The outer diameter of the sleeve 16 is only slightly less than the diameter of the inner passageway 30C of the first adaptor 30 such that when the first end 12A of the water hose 12 is inserted into the inner passageway 30C, the outer surface 16D of the sleeve 16 is only slightly spaced apart from the inner surface 30H and the sleeve 16 is a close fit in the inner passageway 30C. When o-rings 38 are positioned in the grooves 30J in the inner surface 30H of the inner passageway 30G, the o-rings 38 provide a seal between the outer surface 16D of the sleeve 16 and the inner surface 30H of the inner passageway 30C. When the first end 12A of the water hose 12 is inserted into the inner passageway 30C of the first adaptor 30, the outer surface 16D of the sleeve 16 acts with the air groove 30I in the inner surface 30H of the inner passageway 30C and forms an air passageway around an outer circumference of the sleeve 16 and around an inner circumference of the inner passageway 30C. When the o-rings 38 are positioned in grooves on opposite sides of the air groove 30I along the inner passageway 30C, the o-rings 38 prevent air in the air passageway from exiting along the inner passageway 30C between the outer surface 16D of the sleeve 16 and the inner surface 30H of the inner passageway 30C. In the embodiment where the inner passageway 30C has a first portion with a diameter greater than a second portion, the first end 12A of the water hose 12 is inserted into the inner passageway 30C from the first end 30A of the first adaptor 30 until the second end 16B of the sleeve 16 contacts the shoulder 30K between the first and second portion of the inner passageway 30C (FIG. 3). When the first end 12A of the water hose 12 is correctly positioned in the first adaptor 30, the retainer 20 is adjacent the first end 30A of the first adaptor 30. The retainer 20 has extensions which extend beyond the air connector 32 and the air fitting 34 toward the edges of the first adaptor 30. The extensions contact the air connector 32 and the air fitting 34 and prevent the retainer 20 and water hose 12 from rotating in the inner passageway 30C of the first adaptor 30. In one (1) embodiment, the retainer 20 is secured directly to the first end 30A of the first adaptor 30. Once the water hose 12 and the air hose 26 are connected to the first adaptor 30, the protective cap 40 is secured over the first end 30A of the first adaptor 30. The coupling 36 can be connected to the air fitting 34 before or after the protective cap 40 is secured on the first adaptor 30, depending on the length of the air fitting 34 or the coupling 36 or the size of the third opening 40C in the protective cap 40.

In one (1) embodiment, a pressure regulating device 50 is provided between the first adaptor 30 and the air supply 110 (FIG. 5). In one (1) embodiment, the pressure regulating device 50 is clamped onto the first adaptor 30. The pressure regulating device 50 has an input 50A and an output 50B. The input 50A is connected to one (1) end of the air supply hose 108. The other end of the air supply hose 108 is connected to the air supply 110. The amount of inputs 50A on the pressure regulating device 50 depends on the number of air supply tubes 108. A connector hose 106 extends from the outlet 50B of the pressure regulating device 50 to the quick connect coupling 36 or the second air hole 30G of the first adaptor 30. The number of outputs 50B depends on the number of connector hoses 106 connected to the first adaptor 30. The pressure regulating device 50 has an input gauge 50C which enables a user to determine the pressure of the air exiting the air supply 110 and entering the pressure regulating device 50. The pressure regulating device 50 also has an output gauge 50D which enables a user to determine the pressure of the air exiting the pressure regulating device 50 and entering the first adaptor 30 and air hose 26. The pressure regulating device 50 allows a user to regulate or control the pressure of the air exiting the pressure regulating device 50 and entering the air hose 26. The means used to regulate the pressure of the air can be any means well known in the art for controlling air pressure. In one (1) embodiment, the pressure regulating device 50 regulates the pressure of the air from the air supply 110 to between about 75 to 500 psig before the air exits the pressure regulating device 50 and enters the first adaptor 30 and the air hose 26. In another embodiment, a regulator is not used. In this embodiment, the pressure of the air entering the air hose 26 is essentially equal to the pressure of the air exiting the air supply 110. In one (1) embodiment, the air hose 26 can be provided with air at a high pressure and the air from the air hose 26 used to re-energize the firefighters air tanks 162.

The breathing apparatus for the firefighter 150 includes a first breathing hose 154, a second breathing hose 156, a regulator 158 and a mask 160 and at least one (1) air tank 162. In one (1) embodiment, the regulator 158 is directly mounted on the mask 160. The regulator 158 reduces the pressure of the air to a breathing pressure for the firefighter 150. In one (1) embodiment, the breathing apparatus includes a second regulator (not shown) which reduces high pressure, compressed gas which is then fed to the regulator 158 for further pressure reduction. The first breathing hose 154 extends between the second adaptor 42 and the mask 160 of the firefighter 150. The second breathing hose 156 extends between the air tank 162 and the regulator 158 and provides air from the tank 162 to the firefighter 150. In one (1) embodiment, the first breathing hose 154 is connected at one (1) end to a Y-connector in the second breathing hose 156 and is connected at the other end to the quick connect coupling 36 in the second air hole of the second adaptor 42.

In one (1) embodiment, the air and water supply system 100 including the hose apparatus 10 is used as the primary breathing system or source of air for firefighters 150 during a fire. In one (1) embodiment, the hose apparatus 10 is used as the last section of the water hose used by the firefighters 150 (FIG. 1). Limiting use of the hose apparatus 10 to a single section of the firefighting hose, eliminates the need to connect the air hoses 26 from several hose apparatuses 10 together. This reduces the risk of air leakage and also reduces the possibility of damage to the air hose 26 which could result in air leakage. Air leakage in high pressure compressed air systems could potentially be dangerous since the leaked air could feed the fire. Any number of standard water hoses 102 can be used to allow the needed length, provided the last hose is the hose apparatus 10. In one (1) embodiment, the hose apparatus 10 has a length of between 50 and 200 feet (15.24 and 60.96 m). However, it is understood that the hose apparatus 10 can be of any length.

To use the hose apparatus 10 in the air and water supply system 100, the first adaptor 30 of the hose apparatus 10 is attached to an adaptor at the end of the last section of standard water hose 102. The other end of the standard water hose 102 is connected to a source of water. Alternatively, if only the hose apparatus 10 is used, the first adaptor 30 of the hose apparatus 10 is connected directly to the water supply. The air supply 110 is positioned adjacent the first adaptor 30 of the hose apparatus 10. The air supply tube 108 for the air supply 110 is connected to the coupling 36 on the air fitting 34 on the first adaptor 30 and the air supply 110 is turned on. In the embodiment having the pressure regulating device 50, the air supply tube 108 is connected to the air inlet 50A of the pressure regulating device 50 and the connector hose 106 is connected to the air outlet 50B. The pressure regulating device 50 is then used to adjust or control the pressure of the air entering the first air hole 30H and into the air hose 26. In one (1) embodiment, the air supply 110 provides air at a pressure of at least 75 psig with or without the use of a pressure regulating device 50 or regulator. However, it is understood that the pressure of the air entering the air hose 26 must be great enough to provide sufficient air to the firefighters 150 at the other end of the hose apparatus 10. The pressure needed depends on the length of the hose apparatus 10, the inner diameter of the air hose 26 and the number of persons or firefighters 150 using the hose apparatus 10. It is believed that 75 psig is the lowest pressure which can be used in a 50 ft (1524 cm) hose apparatus 10 being used by two (2) persons. It is understood that other breathable gases could also be provided through the air hose 26 of the hose apparatus 10. The air moves from the air supply 110 through the coupling 36 into the second air hole 30G in the first adaptor 30. The air moves through the second air hole 30G into the air groove 30I in the inner passageway 30C of the first adaptor 30. The air then moves around the air groove 30I and exits the air groove 30I through the first air hole 30H in the first adaptor 30 into the first end 26A of the air hose 26. The seals in the inner surface 30H of the inner passageway 30C of the first adaptor 30 prevent the air from escaping the air passageway formed by the outer surface 16D of the sleeve 16 and the air groove 30I. The air travels the length of the air hose 26 to the first air hole in the second adaptor 42. The air then moves through the first air hole into the air groove 30I in the inner passageway of the second adaptor 42 and into the second air hole in the second adaptor 42. The air exits the second adaptor 42 through the coupling 36 into the first breathing hose 154 of the breathing apparatus of the firefighter 150. A nozzle 112 is connected to the second end of the second adaptor 42 and is provided to one or more firefighters 150. Each firefighter 150 then connects the first breathing hose 154 of his breathing apparatus to the quick connect coupling 36 on the second air hole of the second adaptor 42. Connecting the first breathing hose 154 to the coupling 36 opens the valve in the coupling 36 and allows air to flow from the air hose 26 through the second adaptor 42 through the first breathing hose 154 to the mask 160. When the first breathing hose 154 is disconnected from the coupling 36, the valve in the coupling 36 closes and air can not exit the coupling 36. A secondary hose and mask (not shown) could also be connected to any remaining second air holes. The secondary hose and mask can then be used to provide air to a civilian trapped in a fire. Where the air and water supply system 100 is the primary air supply system, the firefighter 150 does not turn on the tanks 162 of the breathing apparatus unless the hose apparatus 10 stops providing air such as if the air supply 110 becomes depleted or the air hose 26 is blocked. In one (1) embodiment, the air tanks 162 are not on when the hose apparatus 10 is being used and is operating correctly. In an alternative embodiment, where the breathing apparatus does not have a second breathing hose 156, the firefighter 150 disconnects the first breathing hose 154 from the tanks 162 and connects the first breathing hose 154 to the hose apparatus 10. Once the firefighters 150 are connected to the hose apparatus 10 and are holding the nozzle 112, the water supply is turned on.

It is intended that the foregoing description be only illustrative of the present invention and that the present invention be limited only by the hereinafter appended claims.

We claim:

1. A hose apparatus for providing air and water to a firefighter which comprises:
(a) a water hose having opposed ends with an inner passageway extending therebetween;
(b) at least one air hose having opposed ends with an inner passageway extending therebetween and positioned adjacent to the water hose so that the first end of the air hose is adjacent to the first end of the water hose; and
(c) an adaptor having a first end and a second end with an inner passageway extending therebetween and having a first air hole, a second air hole, the inner passageway having an inner surface with an air groove wherein the adaptor is configured to be connected to one end of the water hose and one end of the air hose so that the inner passageway of the adaptor is in fluid communication with the inner passageway of the water hose and the air groove in the inner surface of the inner passageway is in fluid communication with the inner passageway of the air hose.

2. The hose apparatus of claim 1 wherein the inner passageway of the adaptor has a cylindrical shape and wherein the air groove has a circular shape and extends around a circumference of the inner surface of the inner passageway.

3. The hose apparatus of claim 1 wherein one end of the water hose is connected to the adaptor by inserting the one end of the water hose into the inner passageway of the adaptor, wherein a sleeve is positioned on the one end of the water hose, and wherein when the adaptor is connected to the water hose, an outer surface of the sleeve and the inner surface of the inner passageway form an air passageway along the air groove.

4. The hose apparatus of claim 3 wherein the inner surface of the inner passageway has seals which form a seal between the outer surface of the sleeve and the inner surface of the inner passageway and prevent air from escaping from the air passageway between the sleeve and the inner passageway.

5. The hose apparatus of claim 3 wherein a retainer is secured to the sleeve to prevent the one end of the water hose from rotating in the inner passageway of the adaptor.

6. The hose apparatus of claim 1 wherein a pair of air hoses are positioned approximately 180° apart around a circumference of the water hose.

7. The hose apparatus of claim 6 wherein an outer cover extends around the air hoses and the water hose and holds the air hoses adjacent the water hose in a spaced apart position.

8. The hose apparatus of claim 1 wherein the water hose is positioned in the inner passageway of the adaptor at the first end of the adaptor and wherein the first air hole and second air hole are adjacent to the first end of the adaptor.

9. The hose apparatus of claim 8 wherein a diameter of the inner passageway of the adaptor at the second end of the adaptor is less than a diameter of the inner passageway adjacent the first end of the adaptor, and wherein the air groove is in the inner surface of the inner passageway adjacent the first end of the adaptor.

10. The hose apparatus of claim 1 wherein there are two adaptors and the adaptors are secured to the opposed ends of the water hose and the air hose.

11. The hose apparatus of claim 1 wherein a protective cap is secured onto the first end of the adaptor.

12. The hose apparatus of claim 11 wherein the protective cap has a first opening to allow the water hose to pass through the protective cap, a second opening to allow the air hose to pass through the protective cap and a third opening to allow access to the second air hole in the first end of the adaptor.

13. The hose apparatus of claim 1 wherein a pressure regulating device is connected to the second air hole of the adaptor and wherein as air enters the pressure regulating device, the pressure regulating device regulates a pressure of the air so that air exiting the pressure regulating device into the second air hole of the adaptor has a preset pressure.

14. The hose apparatus of claim 13 wherein the pressure regulating device is mounted on the adaptor.

15. An adaptor for mounting on an end of a hose apparatus having a water hose and an air hose, which comprises:
(a) a first end configured to receive an end of the water hose of the hose apparatus and a second end with an inner passageway extending therebetween, the inner passageway having an inner surface, the inner surface having an air groove;
(b) a first air hole in the first end in fluid communication with the air groove and configured to connect to the air hose of the hose apparatus; and
(c) a second air hole in the first end in fluid communication with the air groove.

16. The adaptor of claim 15 wherein the second air hole is configured to connect to an air supply and the second end of the adaptor is configured to connect to a water supply.

17. The adaptor of claim 15 wherein the second air hole is configured to connect to a breathing hose of a firefighter and the second end of the adaptor is configured to connect to a nozzle for directing water exiting the water hose.

18. The adaptor of claim 15 wherein the inner surface of the inner passageway has seals adjacent the air groove, wherein a sleeve is provided on the water hose and wherein when the water hose having the sleeve is inserted into the inner passageway, an outer surface of the sleeve mates with the inner surface of the inner passageway adjacent to the air groove to form an air passageway along the air groove and the seals form a seal around the air passageway to prevent air from escaping the air passageway between the sleeve and the inner passageway.

19. A method for providing air and water to a firefighter during a fire which comprises the steps of:
(a) providing a hose apparatus including a water hose having opposed first and second ends with an inner passageway extending therebetween and an air hose having opposed first and second ends with an inner passageway extending therebetween and positioned so that the first end of the air hose is adjacent the first end of the water hose; and a first adaptor having a first end and a second end and a first air hole and a second air hole, the first adaptor having an inner passageway with an inner surface having an air groove, the first adaptor connected at the second end to the first end of the water hose and at the first end to the first end of the air hose so that the inner passageway of the first adaptor is in fluid communication with the inner passageway of the water hose and the air groove is in fluid communication with the inner passageway of the air hose and a second adaptor having a first end and a second end and a first and second air hole, the second adaptor having an inner passageway with an inner surface having an air groove, the second adaptor connected to the second end of the water hose and the second end of the air hose so that the inner passageway of the second adaptor is in fluid communication with the inner passageway of the water hose and the inner passageway of the air hose is in fluid communication with the air groove of the second adaptor;
(b) connecting a water supply to the inner passageway of the first adaptor;
(c) connecting an air supply to the second air hole in the first adaptor;
(d) connecting a breathing hose for the firefighter to the second air hole in the second adaptor;
(e) providing water from the water supply through the first adaptor and the water hose and through the second adaptor and out through the second adaptor; and
(f) providing air from the air supply through the second air hole of the first adaptor to the air groove of the first adaptor to the first air hole of the first adaptor to the air hose to the first air hole in the second adaptor through the air groove of the second adaptor to the second air hole of the second adaptor and to the breathing hose for the firefighter.

20. The method of claim 19 wherein a pressure regulating device is connected to the first adaptor wherein in step (c), the air supply is connected to the pressure regulating device and the pressure regulating device is connected to the second air hole, and wherein, further in step (f), a pressure of the air from the air supply is measured and a pressure of the air exiting the pressure regulating device into the second air hole of the first adaptor is regulated to a predetermined pressure to control the pressure of the air provided to the breathing hose for the firefighter.

21. The method of claim 19 wherein in step (f), the predetermined pressure is at least 75 psig.

22. The method of claim 19 wherein the first air hole and the second air hole are located on the first end of the first adaptor and the first air hole and the second air hole are located on the first end of the second adaptor and wherein the first end of the water hose is positioned in the inner passageway of the first adaptor at the first end of the second adaptor and the second end of the water hose is positioned in the inner passageway of the second adaptor at the first end of the second adaptor.

23. The method of claim 19 wherein a coupling having a valve is connected to the second air hole in the second adaptor and wherein in step (d), the breathing hose is connected to the coupling and wherein when the breathing hose is connected to the coupling, the valve opens and air in the air hose is provided to the breathing hose and wherein when the breathing hose is disconnected from the coupling, the valve closes and air does not exit through the coupling.
